(19) United States
(12) Patent Application Publication
(10) Pub. No.: US 2008/0029222 A1
(43) Pub. Date: Feb. 7, 2008

(54) Optical disc labeling device

(76) Inventor: Shu-Chi Hong, Taipei City (TW)

Correspondence Address: BIRCH STEWART KOLASCH & BIRCH, PO BOX 747, FALLS CHURCH, VA, 22040-0747, US

(21) Appl. No.: 11/498,717

(22) Filed: Aug. 4, 2006

(51) Int. Cl. B32B 37/00

(52) U.S. Cl. 156/556

(57) ABSTRACT

An optical disc labeling device comprises a label seat, an optical disc seat, a base and a driving unit. The label seat is disposed on the base and has a through-hole at the center thereof, and the optical disc seat may outcrop from the through-hole. The driving unit is installed on the base and joined to the optical disc seat. A label and an optical disc are respectively placed on the label seat and the optical disc seat, and the adhesive side of the label and the to-be-labeled side of the optical disc are faced to each other. When the optical disc seat is pressed down, the to-be-labeled side of the optical disc approaches and finally sticks onto the adhesive side of the label. When the optical disc seat is released from the pressing force, the driving unit will gradually push back the optical disc seat.

### FIELD OF THE INVENTION

The present invention relates to the structure of an optical disc labeling device, particularly to an optical disc labeling device with an improved driving unit.

### BACKGROUND OF THE INVENTION

The optical disc is a storage medium used to store digital data. With the popularization of the disc burner, the probability of using the optical disc to store data grows. However, the user cannot learn the contents of the data stored in an optical disc from the appearance of the optical disc. Therefore, the user has to make marks on optical discs, and the marks are often made with a maker pen. However, the ink of the marker pen is harmful to health. Besides, the time consumed in making marks grows with the quantity of optical discs and the contents of the optical discs. Otherwise, an optical disc label may also be used to indicate the contents of an optical disc. However, a common user is hard to afford the expensive conventional optical disc labeling device. Therefore, a simple and low-cost optical disc labeling device is an objective the manufacturers endeavor to achieve.

A U.S. Pat. No. 5,783,033 disclosed a “Labeling Device”, which comprises: a label plate, a disc support rod, a cylinder and a spring. The disc support rod penetrates the label plate. The spring is installed inside the cylinder and below the disc support rod. A label is placed on the label plate with the adhesive side of the label faced upward. An optical disc is placed on the disc support rod with the to-be-labeled side faced downward. When the disc support rod is pressed down, a portion of the disc support rod will be immersed below the label plate, and the optical disc sticks onto the label. When the disc support rod is released from the pressing force, the spring will restore the disc support rod back to the original position. However, the disc support rod has no further support and is likely to deflect. Therefore, the label is likely to be misarranged. Besides, the optical disc is apt to be scratched when it is suddenly bounced back by the spring. Thus, the user needs a higher craftiness to operate such a device.

### SUMMARY OF THE INVENTION

The objective of the present invention is to provide an optical disc labeling device having an improved driving unit, which can precisely stick a label onto an optical disc and can stably push back the optical disc to the normal position.

According to one preferred embodiment, the optical disc labeling device of the present invention comprises: a label seat, an optical disc seat, a base and a driving unit. The label seat is disposed on the base and has a through-hole at the center thereof, and the optical disc seat may outcrop from the through-hole. The driving unit has a driving shaft, a braking element and a spring. The driving shaft is installed on the base and joined to the optical disc seat. The spring is installed inside the driving shaft and supports the optical disc seat, to which the driving shaft is joined. The braking element is installed on the base and engages the driving shaft. When not pressed, the optical disc seat is at a normal position. The adhesive side of the label is faced upward, and next, the backing sheet of the label is peeled off, and next, the label is flatly placed on the label seat. Next, the optical disc is placed on the optical disc seat with the to-be-labeled side faced downward. Next, the optical disc seat is pressed down and immersed below the label seat; at the same time, the optical disc approaches the label and finally sticks onto the label. When the optical disc seat is released from the pressing force, the spring will spring back the driving shaft. The braking element, which engages the driving shaft, can reduce the spring-back speed. Thus, the optical disc seat is pushed back to the normal position gradually. Further, the scratches caused by the sudden bounceback of the optical disc and the deviation of label installation are also decreased.

### BRIEF DESCRIPTION OF THE DRAWINGS

FIG. 1 is a perspective view schematically showing the appearance of the optical disc labeling device according to one preferred embodiment of the present invention.

FIG. 2 is a first exploded view schematically showing the optical disc labeling device according to one preferred embodiment of the present invention.

FIG. 3 is a second exploded view schematically showing the optical disc labeling device according to one preferred embodiment of the present invention.

FIG. 4 is a sectional view schematically showing the optical disc labeling device according to one preferred embodiment of the present invention.

FIG. 5A is a first sectional view schematically showing the operation of the optical disc labeling device according to one preferred embodiment of the present invention.

FIG. 5B is a second sectional view schematically showing the operation of the optical disc labeling device according to one preferred embodiment of the present invention.

FIG. 5C is a third sectional view schematically showing the operation of the optical disc labeling device according-to one preferred embodiment of the present invention.

### DETAILED DESCRIPTION OF THE PREFERRED EMBODIMENTS

The technical contents of the present invention are to be described in cooperation with the drawings below.

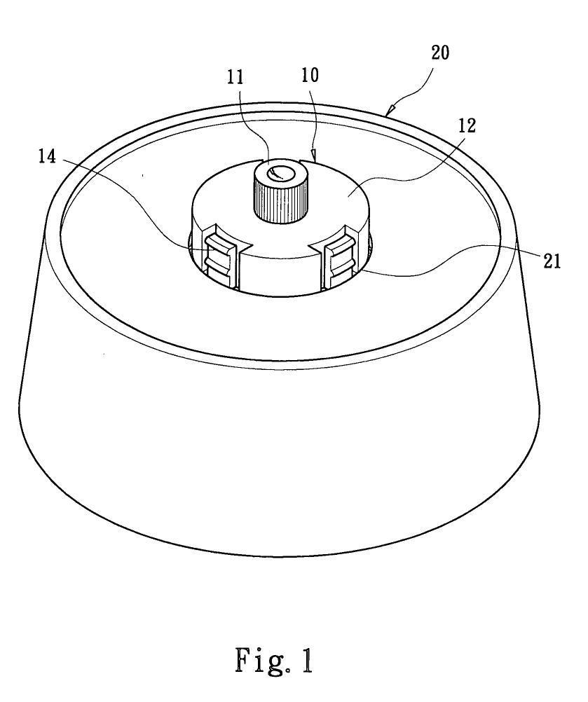

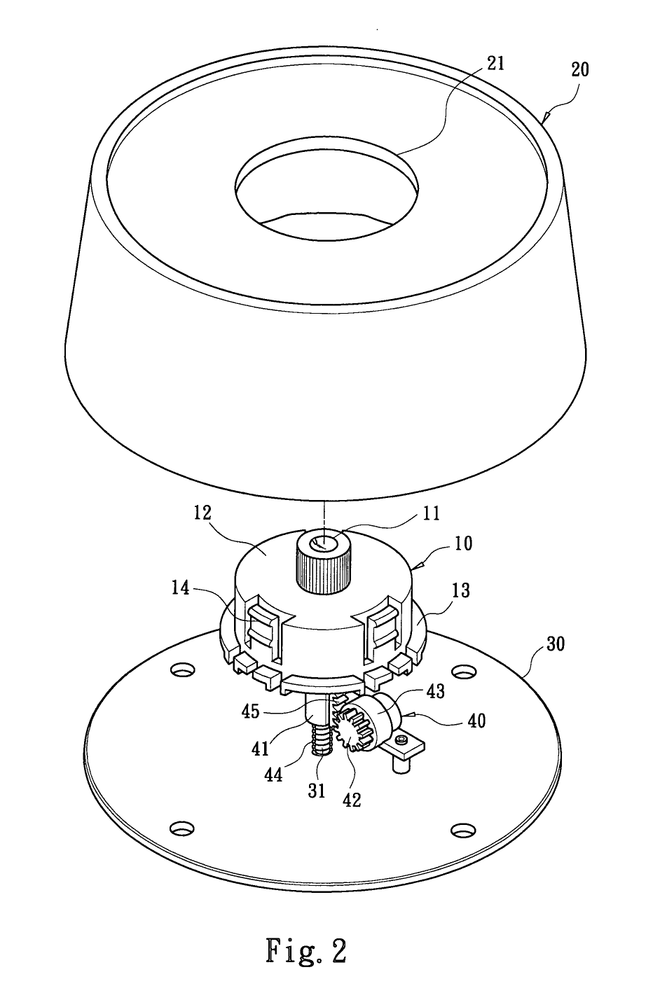

Refer to FIGS. 1 and 2 respectively a perspective view and a first exploded view schematically showing the optical disc labeling device according to one preferred embodiment of the present invention. The labeling device of the present invention comprises: an optical disc seat 10, a label seat 20, a base 30 and a driving unit 40.

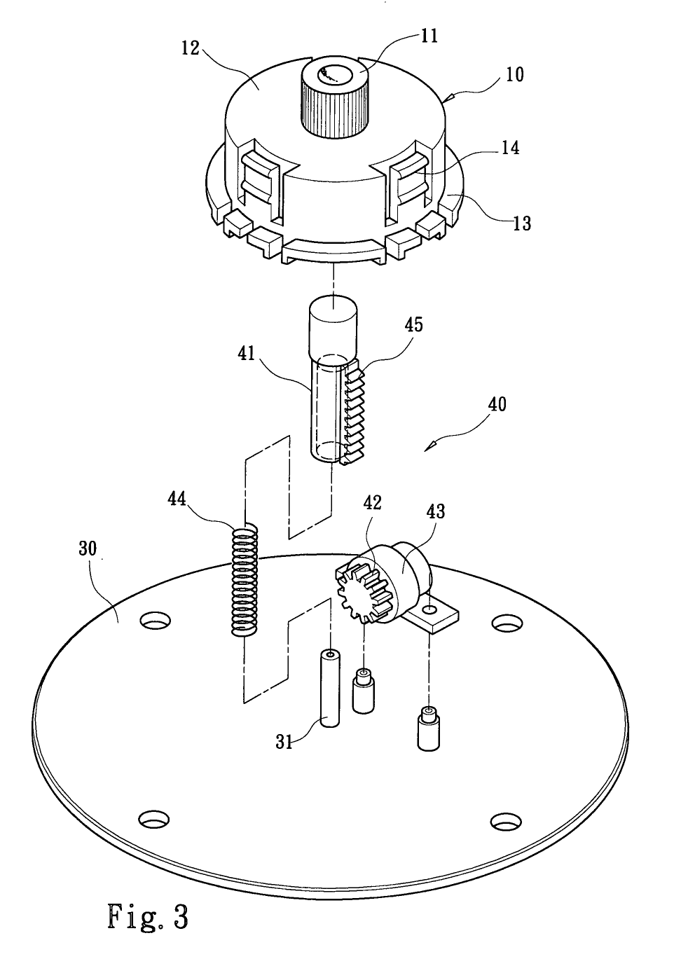

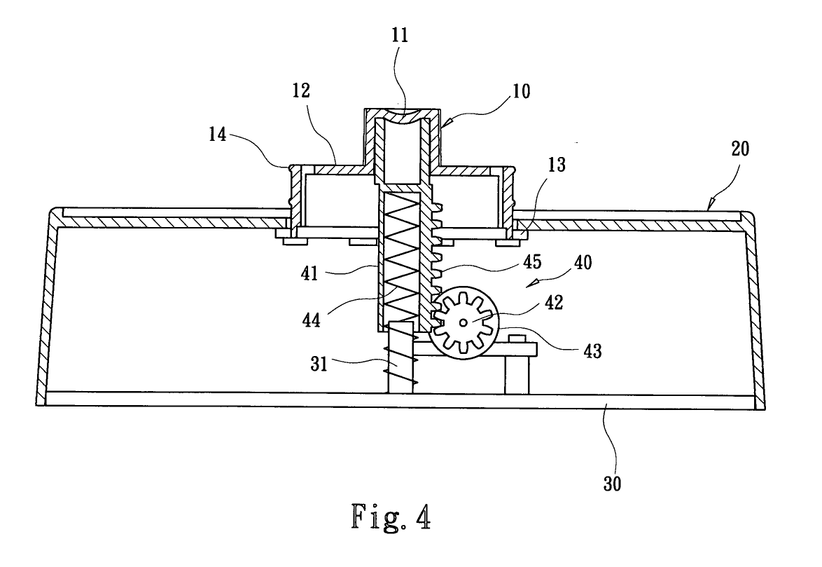

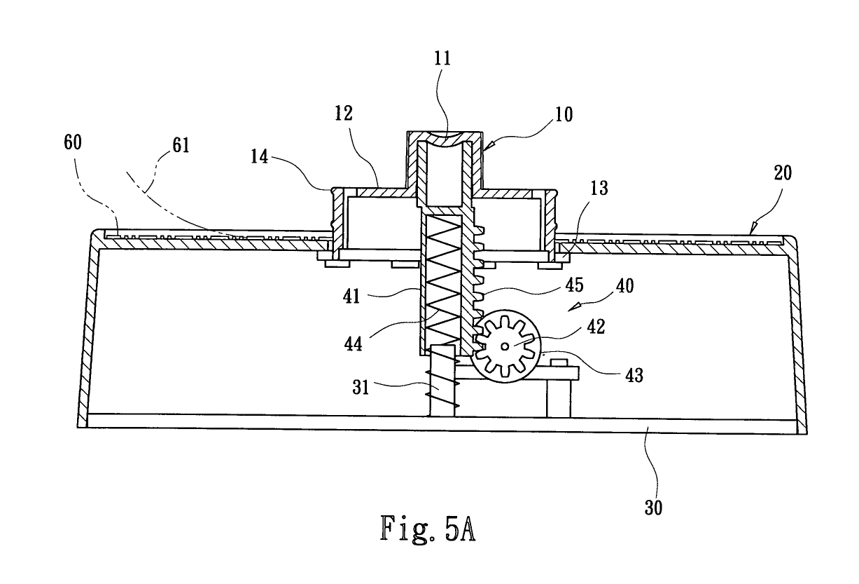

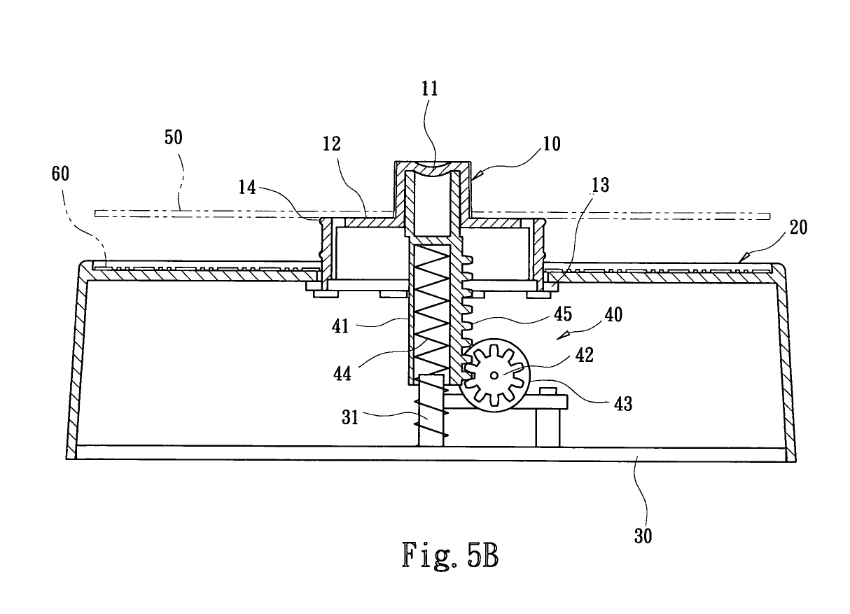

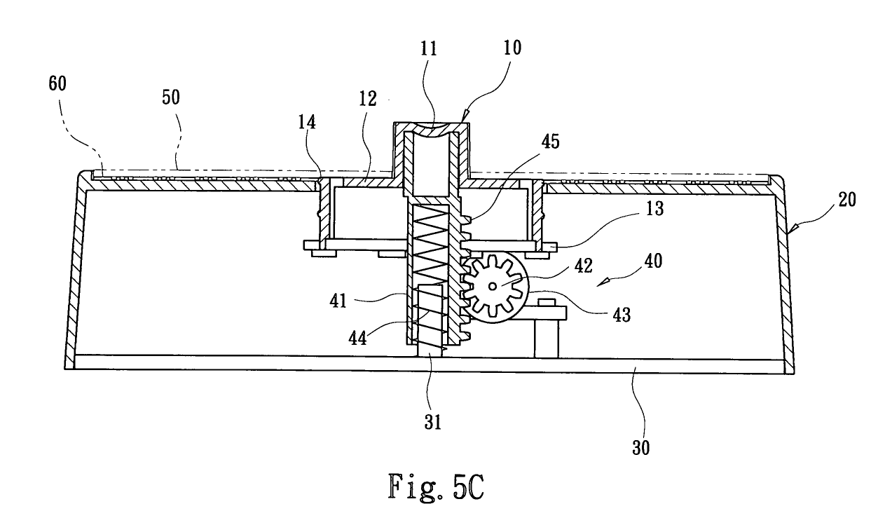

Refer to FIGS. 3 and 4 respectively a second exploded view and a sectional view schematically showing the optical disc labeling device according to one preferred embodiment of the present invention. The label seat 20 is disposed on the base 30 and has a through-hole 21 at the center thereof, and the optical disc seat 10 may outcrop from the through-hole 21. The centers of the optical disc seat 10, the label seat 20 and the base 30 are all at the same axis. The optical disc seat 10 has a press member 11 and a support member 12. The outer diameter of the press member 11 is smaller than that of the support member 12. The outer diameter of the press member 11 is also smaller than the diameter of the central through-hole of an optical disc 50 so that the press member 11 can penetrate the central through-hole of the optical disc 50 without too much looseness. The outer diameter of the support member 12 is greater than the diameter of the central through-hole of the optical disc 50 so that the support member 12 can support the optical disc 50 (as shown in FIG. 5B). The support member 12 has three protruding plates 14 arranged at three equally separated points on the outer diameter of the support member 12. The protruding plate 14 is used to grasp a label 60 from the inner rim thereof. The bottom of the support member 12 also has an annular flange 13, and the annular flange 13 is slightly greater than the through-hole 21 of the label seat 20 and used to limit the optical disc seat 10 lest the optical disc 10 escape from the label seat 20. The base 30 has a post 31 at the center thereof. The driving unit 40 is disposed on the base 30 and has a driving shaft 41, a braking element 43 and a spring 44. The spring 44 is installed inside the driving shaft 41. One end of the driving shaft 41 is joined to the optical disc seat 10, and the other end of the driving shaft 41 sleeves the post 31 of the base 30; thereby, the optical disc seat 10 can move up and down. One side of the driving shaft 41 has a gear rack 45; the braking element 43 has a gear wheel 42. The braking element 43 is used to reduce the rotation speed of the gear wheel 42 and slow down the movement of the driving shaft 41. The braking element 43 is preferred to be a braking element filled with hydraulic oil. The gear wheel 42 engages the gear rack 45. When not pressed, the optical disc seat 10 is normally at a higher position. When the optical disc seat 10 is pressed down, the driving shaft 41 descends, and the spring 44 is compressed. When the optical disc seat 10 is released from the pressing force, the spring 44 will spring back the optical disc seat 10 and the driving shaft 41. However, the gear wheel 42, which engages the gear rack 45 of the driving shaft 41, will slow down the spring-back speed of the driving shaft 41 and the optical disc seat 10. Thus, the optical disc seat 10 is pushed back to the normal position gradually.

Refer to FIGS. 5A, 5B and 5C sectional views schematically showing the operation of the optical disc labeling device according to one preferred embodiment of the present invention. After a backing sheet 61 of a label 60 is peeled off, the label 60 is flatly placed on the label seat 20 with the adhesive side of the label 60 faced upward. The optical disc 50 is placed on the support member 12 with the to-be-labeled side faced downward. Next, the user presses down the press member 11; then, the driving shaft 41 descends, and the spring 44 is compressed. At the same time, the support member 12 is immersed below the label seat 20, and the protruding plates 14 secure the label 60 to the label seat 20. Simultaneously, the optical disc 50 approaches the label 60 and finally sticks onto the label 60. Then, the press member 11 is released from the pressing force, and the spring 44 will spring back the optical disc seat 10 and the driving shaft 41. However, the gear wheel 42, which engages the gear rack 45 of the driving shaft 41, will slow down the spring-back speed of the driving shaft 41 and the optical disc seat 10. Thus, the optical disc seat 10 is pushed back to the normal position gradually. Therefore, the optical disc labeling device of the present invention can apply the label 60 onto the optical disc 50 smooth and flatly without the installation deviation of the label 60. Further, in the present invention, the optical disc seat 10 is pushed back to the normal position gradually, and the scratches caused by the sudden bounceback of the optical disc 50 are decreased.

Those described are the preferred embodiments to exemplify the present invention. However, it is not intended to limit the scope of the present invention. Any equivalent modification and variation according to the spirit of the present invention is to be also included the scope of the present invention.

What is claimed is:

1. An optical disc labeling device, used to stick a label onto an optical disc, comprising:
a base having a post at the center thereof;
a label seat used to accommodate said label;
an optical disc seat having a press member and a support member, wherein the outer diameter of said press member is smaller than that of said support member, and said optical disc can be supported by said support member; and
a driving unit having a driving shaft, a braking element and a spring, wherein said spring is installed inside said driving shaft; one end of said driving shaft is joined to said optical disc seat, and the other end of said driving shaft sleeves said post of said base; thereby, said optical disc seat can move up and down; one side of said driving shaft has a gear rack, and said braking element has a gear wheel, and said gear wheel engages with said gear rack; when not pressed, said optical disc seat is at a normal position; when said optical disc seat is pressed down, said driving shaft descends, and said spring is compressed; when said optical disc seat is released from the pressing force, said spring will spring back said driving shaft; said gear wheel, which engages said gear rack, will slow down the spring-back speed of said driving shaft; thus, said optical disc seat is pushed back to said normal position gradually.

2. The optical disc labeling device according to claim 1, wherein the bottom of said support member has an annular flange, and said annular flange is slightly greater than the through-hole of said label seat and used to limit said optical disc seat lest said optical disc seat escape from said label seat.

3. The optical disc labeling device according to claim 1, wherein said support member has three protruding plates used to grasp said label from the inner rim of said label.
